(19) United States
(12) Patent Application Publication
(10) Pub. No.: US 2005/0278544 A1
(43) Pub. Date: Dec. 15, 2005

(54) Removable data storage medium and associated marketing interface

(76) Inventor: Arthur Baxter, Chicago, IL (US)

Correspondence Address: EDWIN TARVER, 20121 VENTURA BOULEVARD, SUITE 302, WOODLAND HILLS, CA, 91364, US

(21) Appl. No.: 11/151,882

(22) Filed: Jun. 13, 2005

Related U.S. Application Data
(60) Provisional application No. 60/579,356, filed on Jun. 14, 2004.

(51) Int. Cl. G06F 17/60

(52) U.S. Cl. 713/182

(57) ABSTRACT

The present invention is a portable storage device containing proprietary software that protects personal identifiable information by redirecting cached data generated from Internet browsing and computer activities such as: history, cookies, favorites, emails, and passwords, from a computer hard drive onto the removable storage device. The present invention also incorporates a Web-based marketing and advertising communication application, to offer a marketing tool that allows instantaneous customization of advertisements based on a computer user's preferences. The present invention also allows use of the portable storage device while shopping by coupling a radio frequency identification chip with the portable storage device, and installing transceivers in stores for identifying the device and its user.

### CROSS-REFERENCE TO RELATED APPLICATIONS

This is a utility patent application which claims benefit of U.S. Provisional Application No. 60/579,356 filed on Jun. 14, 2004.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

### I

The present invention, entitled a “Removable Data Storage Medium And Associated Marketing Interface,” relates generally to the fields of computers, identity and security management, and more specifically to a portable storage device given the working title of “BuddyDrive,” which can be connected to a computer and removed, and is capable of not only authenticating and authorizing user identity without revealing personal and private information about that user, but also serves an additional function as a personal security device provided by a trusted source; such as a known sponsor or marketer. A functionality given the working title “BuddyPassport,” is maintained on a web server, and is accessed by the BuddyDrive to facilitate marketing communications that are private and secure between a user, sponsor and/or merchant.

The BuddyPassport functions to authenticate a user's identity to the sponsor of an individual storage device, and in turn authorizes private and secure one-on-one electronic communications between the user and the sponsor. In particular, the communications are designed to allow the sponsor to determine the user's purchasing habits, and offer products more closely related to those habits. By communicating browsing habits to the sponsor, the BuddyPassport helps a sponsor develop an online user behavior profile he can analyze to anticipate and satisfy the user's online needs, by personalizing the user's online experience.

The one-on-one electronic communication between the user and sponsor using the BuddyPassport anticipates a targeted marketing function allowing only the sponsor to view the user's browsing habits, and offer personalized content based on that information. At the same time, the drive performs an identity management and security function, preventing passwords, cookies and other information personal to the user from reaching the computer to which the BuddyDrive is connected. Since this information could otherwise be intercepted and used by third parties, the verification process established by the combination of the BuddyDrive and BuddyPassport through two-level authentication ensures that a user's activities are known only to the sponsor, and assures the sponsor of the user's identity to the benefit of both parties. Since the sponsor and user verify each other's identity through the use of the device, account hi-jacking, identity theft, and other forms of deceptive Internet practices by hackers are mitigated.

It is anticipated that the BuddyPassport information channel created by the BuddyDrive will be sponsored by a marketer or other trusted third party organization, creating a trusted relationship between a user and a sponsor. However, the proprietary process of the BuddyPassport governs the nature of the communication; namely the various types of information that can be received by the sponsor. During the initial authentication of the BuddyDrive, privacy settings are selected by the user and communicated to the BuddyPassport via a process given the working title PrivacyTriggers. The BuddyDrive connects to the BuddyPassport and stores cookies and Internet files. Therefore the device is of value to both the user and the sponsor.

### II

An online computer offers a wealth of information about the person using it to access the Internet. Cookies, leftover session data, history files and other Internet cached data can leave behind an unprecedented amount of information on a computer that has been used to access the Internet. Similarly, online thieves and “bots” (automated identity theft programs) can steal identity information. This information, or “footprint” often reveals confidential data about a user, such as the details of private relationships, demographic profiles, financial records, health issues, religious affiliations, childcare arrangements, etc. The consequences of the theft of this information are wide-ranging; from account hijacking, identity theft and workplace monitoring, to financial and medical data abuse, spamming, and unwanted marketing intrusions, all facilitated by unauthorized access to private information.

Single step authentication with a user ID and password is no longer sufficient to protect a user's digital identity or data on the Internet. Identity theft is the fastest-growing crime in America. It is, literally, the theft of a person's identity to conduct unauthorized transactions on his behalf. Left unaddressed, identity theft can ruin a FICO score, making it difficult to obtain loans, and can increase the interest rate on existing loans and credit cards. More than 11 million people were victimized by identity theft in 2004, and on average, identity thieves stole nearly $7,000 per person. Without identity theft insurance, victims typically spend $800 in out-of-pocket expenses to correct their credit profiles.

At the same time, target marketing on the Internet is a frustrating endeavor. It is frequently very difficult to match online identities with the actual people creating those profiles. For instance, browsing information indicating one set of interests may result in inappropriate marketing when two or more users work on the same computer. Worse yet for online marketers, legitimate cookies may be deleted by firewall and anti-spyware software. This threatens mechanisms of legitimate online tracking and target marketing that are useful to users. Doing Internet business requires constant authentication to ascertain and ensure the identity of users performing specific operations. As well as the concern over identifying authorized parties, Internet businesses must be equally concerned about maintaining the security of their customers' proprietary and private information.

Authentication and authorization systems can be complex and costly, detract from the technological advances offered by online business, and result in inefficiency and reduced market opportunities. Online businesses frequently deploy dozens of applications which create scores of fragmented user repositories, each with different authentication procedures. This presents a problem from a cost and manageability standpoint, and users find it very difficult to keep up with multiple user names and passwords.

Successful businesses are beginning to reject existing user ID and password systems and are turning to cohesive user authentication solutions that provide stronger protection. For example multi-factor authentication devices such as smartcards, one-time password tokens, biometrics analysis, Public Key Infrastructure (PKI), and USB tokens obviate the need for multiple user IDs and passwords. These methods dramatically improve identification by raising the level of security. Although each method is generally better than using a user name and password system, they all differ in cost, ease of deployment, user satisfaction, and flexibility.

### III

Removing data cached by an Internet browser has been addressed heretofore by manual cleaning techniques; specifically, erasing the data wherever it is stored on an individual computer. However, lay computer users have difficulty determining exactly what cached data has been generated from their browsing activities and where it is located. When attempting to remove this data from a computer, a user may accidentally delete important data and cause unnecessary damage to the operating system or any number of applications.

To resolve this problem, mechanisms have been developed with various options to delete cached data, or prevent browsing data from being cached, based on the contents of a website. These mechanisms fail to provide an effective means of transferring or managing cached data for reuse. They presume that a user has a working knowledge of data caching and management tools, a skill that largely remains uncommon among lay users. Furthermore, most existing cleaning systems delete or erase all cookie files. However not all cookies are undesirable. They often come from useful, frequently visited sites, so that familiar information needn't be constantly re-entered. For instance, mapping programs store cookies to remember a user's address for calculating directions.

In light of these issues, there is a need for an efficient convenient method and system for removing or transferring data cached on a computer during a user's browsing session. It is desirable that the data derived from browsing activities and stored on a computer be accessible for future browsing sessions. Furthermore, to restore consumer confidence in online businesses, Internet users need to be assured that their personal data is secure, and not being used for unauthorized purposes.

U.S. Pat. No. 6,851,060 (Shrader) discloses a mechanism that allows web browser users easy access to their authentication and cookie information and provides options to the users to modify or delete this information. This patent exclusively discusses authentication and cookie information and does not cover other data such as temporary Internet files and history that are also cached by the browser.

U.S. Pat. No. 6,744,452 (McBrearty, Mullen, Shieh) discloses a modified web browser application that indicates to the user when a particular web page being displayed is cached. The user has the option to refresh the page if display of the cached page is not desired.

U.S. Pat. No. 6,453,342 (Himmel, Rodriguez) discloses a method and apparatus for selectively storing web content in a cache for a web browser. Each web page is parsed for an indication of whether it is to be stored in cache or not. Responsive to identifying the indication, the web content is either left in the cache or cleared from the cache in response to the browsing session terminating.

U.S. Pat. No. 6,510,458 (Berstis, Rodriguez) discloses a method and system for filtering web pages from being stored in the cache. A user sets preference parameters that prevent web pages from being stored in the cache. Cache filters take a variety of forms such as ratings filters, web page identifier filters, and key word filters, which scan accessed contents of a web page for user selected items. The filtered web page is then blocked from entry in the browser's cache based on the filtering process.

U.S. Pat. No. 6,467,029 (Katayama) discloses a data management apparatus and method for facilitating management of cached data stored by a data-searching unit of a client. When the data searching unit of the client requests data from a data source web server, a caching data managing unit controls the quantity of cached data stored in the data searching unit. Also, the caching data-managing unit can delete, suppress, or move the particular caching data location.

U.S. Pat. No. 6,734,886 (Hagan and Levy) discusses a method of customizing a browsing experience on a website. This method maintains user records in databases, and fetches and displays the pages of the website most relevant to the visitor.

U.S. Pat. No. 6,330,592 (Makuch and Webber) discusses a method for displaying customized web content. Keyword directives cause content in various information categories to be delivered to a web page visitor. The number of keyword directives eventually creates a visitor profile. Over time, this visitor profile can serve as an indicator of a user's preferences. In this way, the invention accumulates visitor profiles unobtrusively, without requiring visitors to fill out a survey or questionnaire. This method creates user profiles based on browsed web page content and any information entered on a website. The invention then delivers personalized pages to the visitor by examining such visitor's profile.

U.S. Pat. No. 6,412,073 (Rangan) discusses an Internet Portal, which presents a personalized page containing bookmarked hyperlinks wherein, upon invocation of a hyperlink by the user, the portal automatically provides any required log-on information required for user access at the destination site. The automated functions of this invention do not provide for secure Internet browsing and fail to establish any secure relationship between the pages sought to be accessed and the Internet Portal page.

Therefore, there is a need for an effective, convenient Internet storage device that can serve as a private and secure information repository, ensure a safe and anonymous Internet browsing atmosphere, and provide a secure identity and authorization verified connection between individual users and Internet marketing businesses that enables a user profile to more accurately reflect the browsing habits of the user.

It is an object of the present invention to provide a reliable, inexpensive, easy to use data storage device that can be carried with a user and employed on virtually any computer, requiring no software installation onto the host or client computer.

A further object of the present invention is to provide a data storage device that enables a user to browse the Internet on any computer without leaving a trace of online activities on the hard drive or in the memory of the computer.

A further object of the present invention is to provide a data storage device that enables a user to browse the Internet (commercially referred to as Protected Browsing) on any computer without leaving any indication of the user's identity on websites that are accessed while using the device.

A further object of the present invention is to provide a data storage device with an interface that securely connects a user of a portable storage device with a sponsor associated with the device, wherein the user is assured that the sponsor is the sole recipient of information gained while using the device, and the sponsor is assured of the identity and authorization of the user.

A further object of the present invention is to provide a data storage device that can be sold as a part of a customizable marketing campaign, wherein a variety of data can be provided regarding a user's identity using registration information obtained through the device. It may be sold as a packaged, turnkey device to sponsors with user defined interfaces pre-installed, and access to a site oriented to a specific sponsor's needs. Additionally the device may be individually sold at a designated outlet, preprogrammed with sponsor information and an interface designed for a specific sponsor.

These and other objects will be further explained in the following Description and related Figures.

### SUMMARY

The present invention comprises a portable information storage device designated as the “BuddyDrive” which may be used in conjunction with a computer running a Windows or similar operating system. When the device is inserted into a USB or similar connection device to the computer, a user is prompted to register the device. Once the device is registered, it operates automatically every time it is connected to a computer, to change the Windows or operating system registry, directing information generated from a web browsing session to the memory of the device rather than the hard drive of the computer. When the device is properly removed, it automatically causes the Windows Registry to revert to its original settings.

The information recorded on the portable storage device is maintained on the device and employed the next time it gets connected to a computer with access to the Internet. The information on the device is used, in a preferred embodiment of the invention, to determine the demographic of the user for targeted marketing purposes using an interface with the working title “BuddyPassport.” Using the BuddyPassport, plus a user password, and a Unique Device Identifier (UDI), the BuddyDrive verifies the identity of a user, and works in conjunction with Internet resources to provide targeted marketing, and selected advertisements to the user based on personal preferences and an evolving Internet browsing profile.

The BuddyPassport database tracks the user's BuddyDrive interactions with the sponsor with the BuddyPassport's four primary panels: First, the Sponsor panel comprises the main window of the BuddyPassport secured web portal. In this field, the sponsor may present his marketing message to the end user of the BuddyDrive. Second, the Service menu is an area to the left of the Sponsor panel that provides additional informational links for the user, populated either by the sponsor, or the manufacturer of the BuddyDrive for additional marketing opportunities such as up-selling and cross-selling. Third, the Protected Browsing Tab provides a tab that opens a secondary browser window. In this secondary window, a user may access the Internet through a hosted proxy, leaving no trace of his surfing activities, or pages visited, on the host computer. Finally, the BuddyPassport Server, which maintains an active dialog between the end user, sponsored web pages and the server database, maintains a history of the user's interactions on the Sponsor Site.

Content delivered to the user's Sponsor panel is administered via a web-based utility which allows a variety of media content, whether static, dynamic or interactive to be delivered on a schedule. It also permits the creation of links for the Service menu, the uploading of new images for the toolbar, and the downloading of reporting data for analysis by the sponsor for marketing purposes.

The UDI is a code unique to each BuddyDrive device, and is used when it connects to the BuddyPassport database. The UDI is embedded within the BuddyDrive software and is accessed during the initial registration of that device between the end user and the BuddyPassport. The UDI is used to authenticate the device on the database and grant access to the BuddyPassport site. The UDI also creates an association between the BuddyPassport database and the end user's browsing activities at the BuddyPassport Sponsor site, allowing a variety of activities such as marketing intelligence, regulatory compliance or administration.

Along with the UDI code, the BuddyDrive and BuddyPassport protect against fraud over the Internet through a two-level authentication system. Other security features include a, SSL and proxy server that cloaks the user's identity using the UDI code.

In one preferred embodiment of the invention, the portable storage device is equipped with a radio frequency transceiver, designed to sense other transceivers in commercial environments and display messages on the device.

The BuddyDrive of the present invention also contemplates a novel marketing method in which the BuddyDrive is sold as a packaged, turnkey solution to the sponsor. This package includes the distribution of a large number of BuddyDrives with installed UDIs and software. One alternative embodiment of this method would allow downloading the UDI and software from the BuddyDrive manufacturer.

The packaged solution also includes access to a basic BuddyPassport site. Since each BuddyDrive device can access the basic BuddyPassport site upon first use, it needs no preliminary updating or programming. An end user must personalize the device with a password when the device is first used and registered. That user must also grant a few PrivacyTriggers, used to ascertain what information is allowed to marketers, during the first authentication. By doing this, the user becomes a BuddyPassport member, and the site begins performing its data mining operations for the sponsor.

PrivacyTriggers refer to touchpoints that govern where and when a marketer may contact a user. In order to gain member privileges in the BuddyPassport, the BuddyDrive user must opt-in to these touchpoints. During the opt-in process, the user defines the sponsor's use of certain touchpoints; what information to disseminate or restrict, and where to disseminate that information. The touchpoints establish the user's market segment. When the user passes a touchpoint, the BuddyPassport back end uses that touchpoint to determine what type of communications the user is seeking and when or how he wants to receive that communication. One or more touchpoints, or PrivacyTriggers may be used in conjunction to make these determinations, and sharing this information can add touchpoints to a user's database. Shopping and purchasing through the BuddyPassport could also add touchpoints. Shopping behavior touchpoints could automatically help the sponsor to build a user profile. The user would initiate the process through purchases, or by activating a sponsored feature. For example, a user who takes advantage of a particular buyer reward indicates an interest. A book purchase might help the sponsor to sell a related DVD.

A sponsor of the BuddyDrive may customize the device with a logo, packaging, and may even require a particular type of memory device that can be tailored to that sponsor's needs for product flexibility. Some of the hardware variations possible in alternate embodiments of the BuddyDrive include removable drives from portable phones and other portable electronic devices.

An alternate marketing method contemplates selling the BuddyDrive through a designated mass distribution outlet such as an advertising and/or promotional marketing specialty house. The sale would still be in mass quantities for end users, but would be more similar to a retail sale approach. A user would still receive the BuddyDrive, and would also enjoy preferred shopping as a member of the basic BuddyPassport site upon registration and authentication.

The BuddyDrive and BuddyPassport system also permits a novel marketing tool. The fact that there are sponsors, allows the drive to be given to an end user for free, and allows the sponsor to make third party deals with other trusted vendors. In this manner, the BuddyDrive may be specifically geared to engender trust between the sponsor and the user, since transactions that are authorized and authenticated via BuddyDrive allow private and secure communication between the user, sponsor or other trusted merchants. By using the BuddyDrive, a user is able to trust the sponsor and the sponsor's ability to secure and protect personal information online and offline. Additionally, since trust is established between the user and the sponsor, the sponsor may introduce other trusted merchants to the user for up-selling or cross-selling opportunities. In this manner, a chain of value is created for all stakeholders via the BuddyDrive/BuddyPassport system. This marketing tool is also intended to function in a mass distribution context via promotional giveaways by large corporate sponsors. Third party merchants might also pay for the privilege of fulfilling referred market requests. In addition, the manufacturer of the device could bill the sponsor for subletting advertising space.

To accomplish the foregoing and related ends, the invention comprises the features hereinafter fully described. The following description and the annexed drawings set forth in detail certain illustrative embodiments of the invention. These embodiments are indicative, however of but a few of the various ways in which the principles of the invention may be employed.

### BRIEF DESCRIPTION OF THE FIGURES

FIG. 1 is a block diagram of the present invention, wherein the BuddyDrive of the present invention is connected to a computer.

FIG. 2 depicts an embodiment of the BuddyDrive of the present invention.

FIG. 3 depicts the user interface and web browsing screen of the BuddyPassport portal of the present invention.

FIG. 4 depicts one embodiment of the back-end implementation of the BuddyPassport portal of the present invention.

FIG. 5 depicts the toolbar of the present invention.

FIG. 6 shows a radio frequency identification (RFID) circuit chip fixed to the BuddyDrive of the present invention.

FIG. 7 depicts a scenario in which RFID chip fixed on a BuddyDrive is communicating with a transceiver installed in a location.

### REFERENCE NUMERALS

101 . . . Computer
102 . . . Windows Registry
103 . . . Primary Hard Drive
104 . . . Internet Browser
105 . . . BuddyDrive
201 . . . BuddyDrive Processor and Memory Portion
202 . . . Computer Connector
203 . . . Key Chain
204 . . . Keys
301 . . . BuddyPassport Outer Frame
302 . . . BuddyPassport Inner Window
303 . . . BuddyPassport Protected Browsing panel
304 . . . BuddyPassport Service menu
305 . . . BuddyPassport Rewards panel
401 . . . BuddyDrive
402 . . . User Computer
403 . . . Internet Link
404 . . . BuddyDrive/BuddyPassport Server
405 . . . Sponsor Server
406 . . . Back end BuddyDrive/BuddyPassport Server
407 . . . Back end Sponsor Server
408 . . . Mainframe Computer
501 . . . Login Icon
502 . . . Email Access Icon
503 . . . File Synchronizer Icon
504 . . . Internet Access Icon
505 . . . Special Utility Icon
601 . . . RFID Chip
602 . . . RFID Equipped BuddyDrive
603 . . . Display Panel
701 . . . RFID Chip
702 . . . RFID Chip Equipped Buddy Drive
703 . . . Display Panel
704 . . . Hospital Admissions Center
705 . . . Transceiver
706 . . . BuddyDrive Sponsor Back End System
707 . . . Radio Frequency Waves

### DETAILED DESCRIPTION

The present invention is a portable storage device, designated the “BuddyDrive,” containing proprietary software, which protects personal privacy by redirecting cached data generated during Internet browsing, such as: history, cookies, favorites, emails, and passwords, among others. It causes information that would normally be recorded onto the hard drive of a computer to be redirected onto the memory of the BuddyDrive. In addition, the present invention incorporates a secure, private web-based communication application, designated the “BuddyPassport” to incorporate a personalized marketing capability into the BuddyDrive. Finally, the present invention comprises a novel marketing tool relying on the BuddyDrive/BuddyPassport interface to build trusted relationships between sponsors and users of the invention. The present invention will be described with reference to the aforementioned drawings. One of ordinary skill in the art should appreciate that the applications described herein are examples of how the broader concept can be applied.

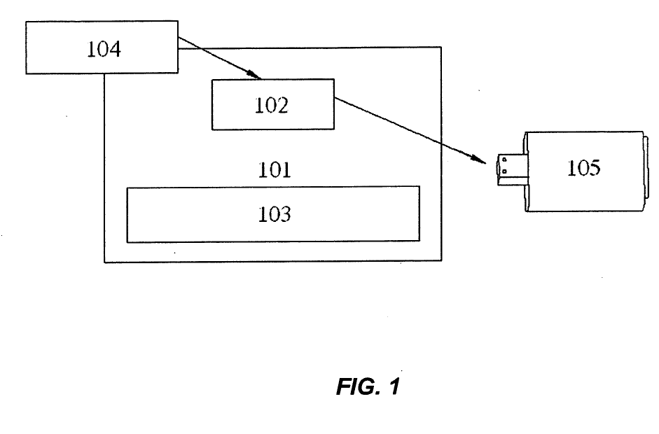

FIG. 1 is a block diagram showing storage of browser data in an arrangement with the BuddyDrive of the present invention connected to a computer. The diagram displays a computer 101, Windows Registry 102, primary hard drive 103, Internet browser 104, and BuddyDrive 105. The computer 101 comprises a primary hard drive 103, which serves as the default data storage device. The Windows Registry 102 is a part of the Windows operating system settings [not shown]. An Internet browser 104 operates in connection with the Windows operating system.

The BuddyDrive 105 consists of a memory portion, housing, a connector and a cover. The memory portion may accommodate a broad range of memory storage capabilities and is connected to an internal processor. The housing may be designed in a variety of ways, in one preferred embodiment as a shock-resistant key fob, or other small device, and the connector may be any connection mechanism with which a computer connects to peripheral devices, including radio frequency or Infrared light.

As a user performs the initial setup of a typical Internet browser 104, a selection can be made that indicates where to store temporary Internet files. This setting is maintained in the Windows Registry 102. Normally, when typical default settings are selected, temporary Internet files are saved to the primary hard drive 103. However, when the BuddyDrive 105 is connected to the computer 101, it queries the Windows Registry 102 settings in the operating system for the current location of temporary files. It then changes the Windows Registry 102 settings, instructing the Internet browser 104 to save temporary files on the BuddyDrive 105.

As a user browses the Internet, the Windows operating system makes no distinction between a user's hard drive 103 and the BuddyDrive 105. After the BuddyDrive 105 is connected, and the Windows Registry 102 changed, the computer 101 stores temporary files (history, cookies, passwords etc.) exclusively onto the BuddyDrive 105. When a user finishes browsing, the BuddyDrive 105 is properly disconnected from the computer 101. The computer 101 then reverts back to its normal mode of operation, with no trace of personal information stored on the hard drive 103. The information from BuddyDrive 105 governed Internet sessions is maintained on the BuddyDrive 105.

Each BuddyDrive has a Unique Device Identifier (UDI) consisting of a random pass code (hash code) that resides within the BuddyDrive software and in the BuddyPassport authentication database. The BuddyPassport is responsible for creating the UDI. It is then sent back to the BuddyDrive and stored on the device. When a user enters a password and registers a BuddyDrive, the UDI is sent to the BuddyPassport authentication database, creating a relationship between the individual BuddyDrive and the sponsor in that database. The BuddyDrive then checks for current software updates from the sponsor and manufacturer and prompts the user if updates are available. The BuddyDrive then displays the BuddyDrive toolbar, complete with an image specified by the sponsor, completing the initial registration process.

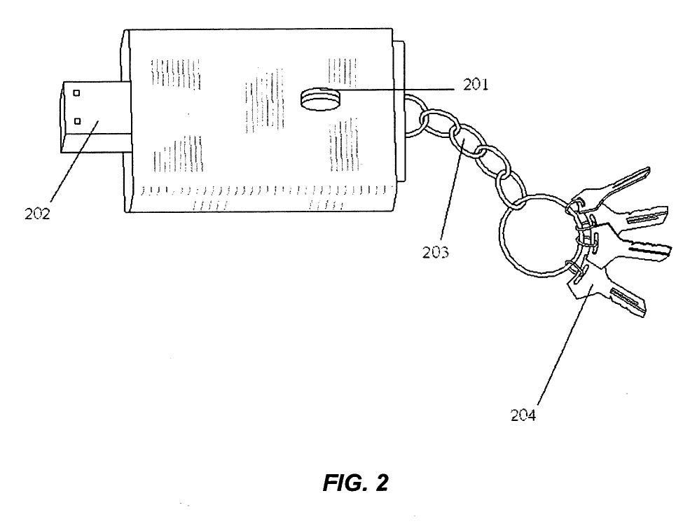

FIG. 2 shows one preferred embodiment of the BuddyDrive 105 of the present invention, linked with ordinary door keys 204. The BuddyDrive comprises a processor and memory portion 201, and a computer connector 202. An optional key chain 203 and keys 204 are also shown. The memory 201 stores temporary files downloaded from the Internet while browsing. The computer connector 202 facilitates the attachment of BuddyDrive to any computer. In the preferred embodiment of FIG. 2, the connector is preferably Universal Serial Bus (USB) port compatible. To highlight the BuddyDrive's portability, it is shown secured with keys 204 attached to the key chain 205.

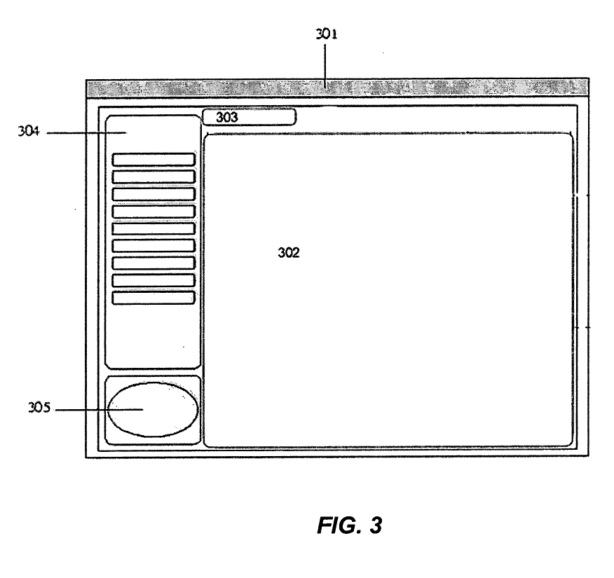

Referring to FIG. 3, the screen of the BuddyPassport portal of the present invention is shown, which is accessed through two-level authentication. In addition, other security features such as a SSL and proxy server cloak the user's identity. The BuddyPassport window consists of an outer frame 301, and an inner window designated a Sponsor panel 302. The outer frame 301 and Sponsor panel 302 appear as one integrated page. The outer frame 301 is generic for all users, and is divided into sections. Each section contains a different suite of utility web applications, operating from within the frame 301. The various sections comprise a Secured Messaging and Protected Browsing panel 303, Services panel 304 and a Rewards panel 305. The Sponsor panel 302 is displayed independently, adjacent to the other sections.

The Sponsor panel 302 is exclusively reserved for marketing and advertising initiatives by sponsors of the BuddyPassport. The Sponsor panel 302 is designed to accommodate Internet applications offered by third parties for marketing purposes. In one preferred embodiment of the present invention, applications provided by third parties operate as marketing tools and engage users with interactive advertisements such as rich media content, streaming video, etc.

After a user registers and activates the BuddyDrive, the BuddyDrive toolbar is displayed each time the BuddyDrive is connected to the computer. When a user clicks on the sponsor's logo, the BuddyDrive sends its specific UDI to the BuddyPassport server. The BuddyPassport server authenticates the login and opens the BuddyPassport portal.

The Sponsor panel 302 is activated and receives targeted marketing through the BuddyPassport. In one preferred embodiment of the present invention, sponsors may derive behavior data through the BuddyDrive once it connects to the BuddyPassport. The BuddyDrive may also be designed to pull data for select services depending on a user's registration information, and the Sponsor panel 302 can operate in real-time, reacting to a user's changing demographic profile in order to tailor and serve up marketing or advertising campaigns to that user.

A Secure Messaging and Private Browsing panel 303 comprises a secure and instant messaging application, which allows users to maintain the privacy of their online conversations with sponsors, merchants, etc. The Private Browsing panel 303 opens another browser window utilizing a proxy to create a secure SSL connection between that desktop instance of Internet Explorer and the proxy. This type of connection enhances the privacy features of the BuddyDrive beyond the local computer and out onto the Internet. The content now being directed to and from the user's computer is encrypted and passed from the browser window through any servers or hosts that exist between the desktop and the proxy. The data is SSL encrypted, making the URLs and contents of sites visited by that instance of the browser virtually unintelligible. Even a local administrator won't have access to the specific sites visited. The only information that appears in the local host's log file is the proxy's internet address. This effectively provides anonymity on the web outside of the Sponsor site.

The Service panel 304 comprises a Merchant Center, which allows either a sponsor or a trusted merchant to cross-sell or cross-market products or services that are geared toward the user, and which compliment the sponsor's offerings.

The Rewards panel 305 comprises reward programs presented by the BuddyPassport sponsor that provide various offers and personal rewards, such as coupons and points to participating users. These reward programs are presented by the sponsor through the BuddyPassport, and the BuddyPassport is capable of displaying any pages provided by the sponsor, with the exception of pages employing a “noframes” command. These programs are targeted to specific end users.

A Secure Chat section [not shown] comprises a secure instant messaging application, which allows users to maintain online conversations in private through the BuddyPassport.

In a preferred embodiment of the present invention, an HTML frame is used for integrating the outer frame with the inner window of the BuddyPassport portal. Further, the utility web applications are preferably coded using software comprising JavaScript, JSP, ASP, VBScript, C#, or a combination. The remaining code for configuring the BuddyPassport portal may be written in software comprising XML, DHTML, HTML, or a combination. Development for the back end is based on software comprising ASP.NET, SQL Server, JSP technology or others. The front end software comprises HTML, DHTML, JavaScript, Flash, VBScript, XML and XSLT.

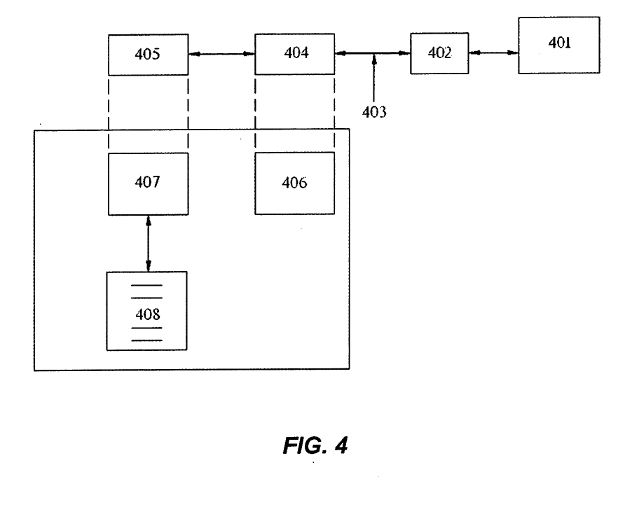

Referring to FIG. 4, one embodiment of the back-end implementation of the BuddyPassport portal is shown. It comprises of user BuddyDrive 401, user computer 402, Internet link 403, Buddy Server 404, Sponsor Server 405, back end Buddy Server 406, back end Sponsor Server 407, and mainframe 408. The user BuddyDrive 401 is connected to the user computer 402 while browsing using the Internet link 403. The front-end software for the BuddyPassport portal outer frame runs on the Buddy Server 404. The front-end software for the BuddyPassport portal inner window runs on the Sponsor Server 405.

For smaller clients, the back end software for the BuddyPassport portal Sponsor panel may run on the Buddy Server 404. The back end software (Active Server Pages) for customizing the BuddyPassport portal runs on the back end Buddy Server 406. The back end software (Active Server Pages) for connecting sponsor forms to the mainframe 408 runs on the back end Sponsor Server 407. Back end data encryption occurs at the mainframe, back end Sponsor Server and back end Buddy Server. The backend system (mainframe, CRM, ERP or data warehouse) 408 is used to store confidential user data and is typically contracted by the sponsor. Any communication from the back end to a mainframe, etc., will not be encrypted as it is assumed that the request has already been authenticated.

The BuddyPassport Server 404 monitors the active dialog between the end user, sponsored web pages and the server database. This maintains the privacy of the BuddyDrive user and still provides sponsors with enough information to know what has captured the interest and focus of the end user.

The sponsor's server database maintains a history of the user's interactions on the sponsor's site through the use of a web service on the hosting server, code integrated with the web content hosted by the BuddyPassport and associated servers and the UDI of the BuddyDrive. Content in the BuddyPassport site is created with the idea of creating a drill down approach to discerning the interests of the user. In conjunction with a particular marketing campaign, the sponsor can aggressively mine the user activities seeing how a user has interacted with the content presented to the user.

Content delivered to the user's Sponsor panel is administered by via a web based admin utility which allows the scheduling and delivery of content, the creation of links for the Service menu via web service applications, the uploading of new images for the toolbar, and the downloading of reporting data for analysis by the sponsor for marketing purposes.

Active server pages on the two back-end servers can be written with Java, C, C++, ASP.net or other languages. Regardless of the Active Server Pages code language, the software remains compatible as is generally known in the art, making this integration possible.

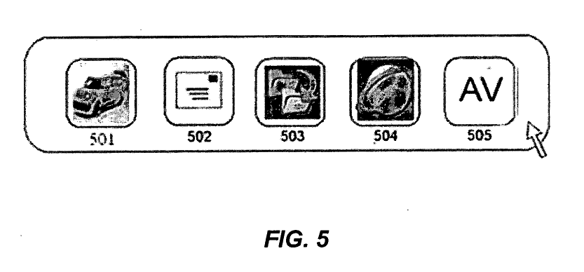

Referring to FIG. 5, a preferred toolbar of the present invention is shown. The toolbar comprises icons representing utility applications which assist in maintaining the privacy of a mobile BuddyDrive user. The software enabling the toolbar is stored on the BuddyDrive memory. The software is Windows Operating System compatible and runs on the host computer to which the BuddyDrive is connected. The icons on the toolbar comprise a login icon 501, an email access icon 502, a file synchronizer icon 503, an Internet access icon 504, and a special utility icon 505.

Clicking the email access icon 502 launches an email program, or allows a user to select from a variety of email programs. Depending on BuddyDrive user preferences and application availability, the user selects one of these programs. When an email program launches, BuddyDrive software redirects the path for data storage to a BuddyDrive location. BuddyDrive software restores the path during the BuddyDrive removal process. Also, the user's personal Internet account settings, including Mail Server, Email Address, Account Name, Password, Incoming Mail Server (POP3), Outgoing Mail Server (SMTP) which are stored on the BuddyDrive and are imported and take effect when the email program is launched. Emails stored on the BuddyDrive memory can be read, and new emails can be sent and received using the email program without leaving a trace on the hard drive of the computer after the BuddyDrive is disconnected.

Clicking on the file synchronizer icon 503 launches a profile window for data exchange between the BuddyDrive and the computer. The profile window enables users to copy data based on parameters such as file size, file type, or date modified, and also helps determine the storage location of files and folders. This function provides the unique ability to know which files are new and which files need to be updated.

Clicking on the Internet access icon 504 launches a secure browser, which is configured by the abovementioned procedure to cache temporary files downloaded from the Internet onto a BuddyDrive location.

Clicking on the special utility icon 505 consisting of plug-ins or links that allow 3^{rd} party applications such as anti-virus protection, anti-spam and/or a firewall to be executed. In an alternate usage of the special utility icon, features convenience packed applications that would automate tasks such as automatic form filling, security, and privacy setting applications.

In an alternate embodiment of the invention, where a particular BuddyDrive and BuddyPassport is sponsored, a sponsor may host the BuddyPassport, and have control over password selection. In this instance, the sponsor password and BuddyDrive UDI will be used to authenticate the user.

Upon login, through the registration process, the BuddyDrive identifies itself with the particular sponsor and links to the BuddyPassport homepage through a secure browser. By employing two-factor authentication, the BuddyPassport verifies that the user fits the prescribed market segement for the BuddyDrive sponsor. Through ASP.NET, or other technology, BuddyPassport matches and tailors sponsor pages to that market segment. The segment match benefits both the user and the sponsor, and the two-factor authentication process prevents fraud and ID theft.

In a preferred embodiment of the present invention, the toolbar software application is designed for storage on a BuddyDrive of at least 64 MB memory and USB 2.0 compliant. The application has an initial footprint on the BuddyDrive of less than 12 MB, allowing the user space for personal files.

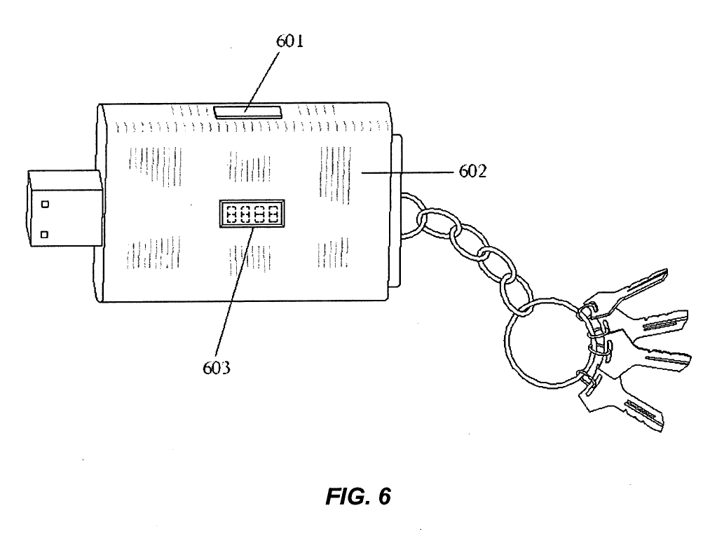

FIG. 6 shows the BuddyDrive of the present invention incorporating a radio frequency identification (RFID) circuit chip. It comprises an RFID chip 601, the BuddyDrive 602, and a display panel 603. The RFID chip 601 is a transponder powered by radio frequencies transmitted by a transceiver. Such transmissions become effective within a short distance (e.g. 100 m) between the transponder 601 and the transceiver. In one embodiment, the BuddyDrive 602 employs a rechargeable battery powered active transponder to send a large amount of data over a long distance. In another embodiment, a passive transponder may be used for economy models of the BuddyDrive 602 to transmit small amounts of data, such as the BuddyDrive UDI.

In a preferred embodiment, the display panel 603 consists of an LCD display without a rear light. A super capacitor charges and operates the display panel 603. A store charges the display panel 603 with RF from the store transceiver. The Buddydrive 602 rectifies the RF and applies it to the super capacitor.

In one preferred embodiment, transceivers are typically operated by businesses sponsoring the BuddyDrive. The BuddyDrive 602 stores data including member user identification information. The display panel 603 is preferably an LCD display panel on which store marketing benefits and offers are displayed in the form of text messages.

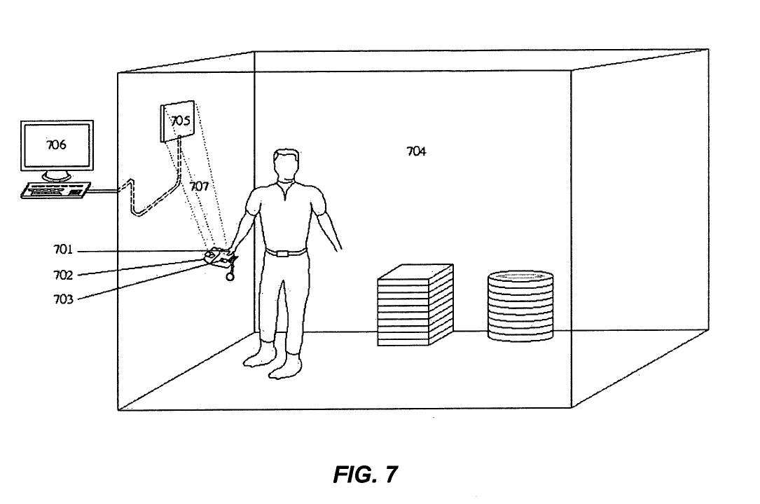

FIG. 7 shows one scenario in which a RFID chip fixed on a BuddyDrive is communicating with a transceiver installed in a hospital. It comprises the RFID chip 701, BuddyDrive 702, display panel 703, hospital admissions center 704, transceiver 705, BuddyDrive sponsor back end system 706, and radio frequency waves 707.

When a BuddyDrive user enters the hospital 704, radio frequency waves 707 transmitted by the hospital transceiver 705 power the RFID chip 701 and identify a BuddyDrive member. An audible signal or “beep” from the RFID chip 701 indicates an authentic member. Full authentication requires both the BuddyDrive UDI and user password. Authentication constitutes the user's permission to register and admit him into hospital care. With the user permission, processes running on the hospital servers and mainframe can then automatically register the user. In that case, after authentication, the RFID chip 701 acquires user identification data from the BuddyDrive memory and transmits it to the hospital transceiver. The hospital matches the BuddyDrive 702 information with complete records in its back-end database 706. At this point, e-registration takes place, and the hospital admits the patient.

The hospital system may confirm e-registration with a message on the display panel 703. The message area may also display the patient's ID. If the hospital participates in member benefits, the display will indicate these. Such benefits will target to the patient's needs. Such benefits might include: meal choices based on the patient's medical diet, therapeutic exercise program reminders, location and directions to the hospital gym, medication deals and reminders, and entertainment and educational programming options available at the hospital, among others.

In cases of disorientation or unconsciousness, the user may be unable to provide admission permission. In these cases, the BuddyDrive device contains crucial contact data. Contacts include the next of kin, care provider and primary care physician. One of these contacts can substitute for the user in granting permission to admit. With this permission, the hospital data center can access patient personal medical records and insurance data.

Other markets that could use the BuddyDrive/BuddyPassport system include lending libraries, video stores, health clubs, or virtually any retail outlet.

Although the present invention has been described in considerable detail with reference to certain preferred versions thereof, other versions are possible. For example, the present invention can be utilized in other contexts such as military installations or in-house corporate departments without departing from the spirit or intent of the invention. Therefore, the spirit and scope of the appended claims should not be limited to the description of the preferred versions contained herein.

Any element in a claim that does not explicitly state “means for” performing a specific function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

1. A portable peripheral memory storage device (device) capable of being connected to and removed from a computer or other electronic devices carrying Windows or other operating system, said device containing memory, a processor, a means of connecting to the computer, and an executable, self-launching computer program;
capable of changing registry settings of the operating system to redirect the storage location for cached and other data resulting from Internet browsing;
redirected, cached data going onto the memory storage device instead of onto the computer hard drive; and
the memory device operating automatically when it is connected to the computer and automatically restoring the registry when the device is properly disconnected from the computer.”

2. A memory storage device associated interface (interface), wherein;
a secure web portal accessed by the device allows secure, private communication between a user and a provider of the memory storage;
a secure web portal accessed by the device encrypts data flowing between a user and the Internet to keep the identity of browsed pages and related information secret; and
the interface, in combination with the device, protects personal information for the user and allows a secure marketing communication channel with a sponsor and/or merchant in order to prevent fraud, ID theft, account hijacking, phishing and other unauthorized hacker activities.

3. A business marketing and user authentication method (method) using the device and interface, wherein the device is distributed for free as a give-away, included in other promotional offers, or otherwise distributed via mass market and mass volume, through corporations with large databases of consumers, to build symbiotic user/sponsor/merchant relationships based on the inherent privacy and security of transactions conducted through the device and interface.

4. The device of claim 1, wherein connecting the device requires no start-up protocol other than an initial registration for the device to operate, and disconnection of the device from the computer requires no dedicated shutdown procedure, and the software runs on the device, not the client/host computer, and is secure and self contained.

5. The device of claim 1, wherein a computer program stored on the device, comprising a means for changing the location of data stored by an operating system on a computer while running applications, including Internet browsing applications;
the means of changing the storage location is accomplished by changing the registry settings of the operating system;
a means for presenting a toolbar menu on a display device, wherein the toolbar comprises icons representing utility applications which assist in maintaining the privacy of a mobile BuddyDrive user, the software enabling the toolbar is stored on the device memory, the software is Windows Operating System compatible and runs on the host computer to which the device is connected, the icons on the toolbar comprise a login icon 501, an email access icon 502, a file synchronizer icon 503, an Internet access icon 504, and a special utility icon; and
a unique device identifier (UDI) consisting of a random pass code that is sent to the device upon registration, and resides within the program and in the interface database to authenticate the device when it is used.

6. The computer program of claim 5, wherein the toolbar displays an Internet access computer program module having means to launch an Internet browser.

7. The computer program of claim 5, wherein the toolbar displays an email access computer program module having a means to launch an email program for sending, receiving, or reading emails; and a means to launch an address book directory of an email program for adding, deleting, or modifying contact information.

8. The computer program of claim 5, wherein the toolbar displays a file synchronizer computer program module having means to copy data from one location to another.

9. The computer program of claim 5, wherein the toolbar displays icons and connects to a computer program module having the means to delete files or folders; a backup computer program module having means to create and store a backup file for the data on any selected drive of the computer; a help computer program module having means to launch a window containing help text for using the toolbar; a current assignment program module having means to display the current assignment being performed by any selected drive of the computer; and an icon showing the space allocation on any selected drive of the computer.

10. The device of claim 1, wherein the device also comprises a radio frequency identification (RFID) chip and a display.

11. The device of claim 10, wherein the RFID chip comprises a passive or active circuit; the passive circuit powered by transceiver transmitting radio frequency waves, and authenticating the device upon receiving data from the RFID chip in the form of a Unique Device Identifier (UDI) via radio frequency waves as a part of its two factor authentication, and the active circuit powered by a power source.

12. The device of claim 10, wherein a sponsor operates the transceiver and the transceiver transmits promotional messages to the device, which are displayed on the device.

13. The interface of claim 2, wherein the interface comprises an outer frame, an inner window wherein the outer frame and inner window are coded separately, the outer frame divided into sections, each containing at least one utility web application, and the inner window displaying advertisements and offers, accepting inputs from users, and customizing the advertisements and offers for a particular user based on those inputs.

14. The interface of claim 2, wherein the interface is sponsored, the sponsor designs the contents of the inner window, and the program displaying contents of the inner window runs on a server owned by the sponsor; and
the interface requires no changes to the sponsor back end, although the sponsor may voluntarily alter his back end after he begins using the interface; however the interface neither requires nor restricts sponsor back end revisions.

15. The interface of claim 13, wherein the interface comprises an outer frame and an inner window appearing as one integrated page, the outer frame being generic for all users and divided into sections, each section containing a different suite of utility web applications operating from within the frame; the various sections comprising a secured messaging and protected browsing panel, services panel, and a rewards panel; and the inner window adjacent to the other sections.

16. The interface of claim 2, wherein information from web browsing activities is verified using a unique device identifier, maintained on the device and on an outside server, and a server database maintains a record of browsing activities to build a user profile.

17. The method of claim 3, wherein a sponsor gives the device as a gift to a user either as an inducement to acquire the user or retain the user as a customer;
creates trust and confidence in dealing with the sponsor through the device's ability to protect and secure the user's personal information online and offline; and
is able to rely on the identity of the user through the device/interface two authentication and authorization, to monitor the user's online habits and offer trusted targeted content from the sponsor, or other trusted merchants, building value in the relationship and permitting up-selling and/or cross-selling opportunities.

18. The method of claim 3, wherein the device is sold in bulk as a packaged, turnkey solution to a sponsor, who may then vend individual devices, which are ready to be used upon registration.

19. The method of claim 3, wherein the devices are sold in bulk through an outlet, such as an ad specialty house, and an end user is able to obtain and register the device according to the sponsor associated with that device.

20. The method of claim 3, wherein the interface allows sponsors to mine trusted data from users of the device, create an online profile of an individual user from the data, and tailor targeted marketing based on the user's profile.
